(19) United States
(12) Patent Application Publication
(10) Pub. No.: US 2025/0300498 A1
(43) Pub. Date: Sep. 25, 2025

(54) ASYMMETRIC SPIRAL ANTENNAS FOR WIRELESS POWER TRANSMISSION AND RECEPTION

(71) Applicant: ENERGOUS CORPORATION, San Jose, CA (US)

(72) Inventor: Alister HOSS, Phoenix, AZ (US)

(21) Appl. No.: 18/961,318

(22) Filed: Nov. 26, 2024

Related U.S. Application Data
(63) Continuation of application No. 17/602,835, filed on Oct. 11, 2021, now Pat. No. 12,155,231.
(60) Provisional application No. 62/831,660, filed on Apr. 9, 2019.

(51) Int. Cl. H02J 50/23; H02J 50/27; H02J 50/40

(52) U.S. Cl. CPC H02J 50/23; H02J 50/27; H02J 50/402

(57) ABSTRACT

A near-field charging system for wirelessly charging electronic devices using electromagnetic energy having a low frequency is provided. The near-field charging system comprises: (A) a transmitting antenna comprising: a first substrate; and a first antenna, coupled to the first substrate, that follows a first meandering pattern having a first length, wherein the transmitting antenna has a first port impedance, and (B) a receiving antenna comprising: a second substrate; and a second antenna, coupled to the second substrate, that follows a second meandering pattern having a second length, wherein: (i) the second length is less than the first length, and (ii) the receiving antenna has a second port impedance that is less than the first port impedance. The transmitting antenna is configured to transmit electromagnetic energy having a frequency at or below 60 MHz to the receiving antenna at an efficiency above 90%.

### RELATED APPLICATION

This Application is a continuation of U.S. application Ser. No. 17/602,835, filed Oct. 11, 2021, which is a U.S. National Stage Application filed under 35 U.S.C. § 371 of PCT Patent Application Serial No. PCT/US2020/027409, filed on Apr. 9, 2020, which claims the benefit of and priority to U.S. Provisional Patent Application No. 62/831,660, filed on Apr. 9, 2019, each of which is herein fully incorporated by reference in its respective entirety.

### TECHNICAL FIELD

The embodiments herein generally relate to near-field wireless power transmission systems (e.g., antennas, software, and devices used in such systems) and, more specifically, to asymmetric spiral antennas for wireless power transmission.

### BACKGROUND

Conventional charging pads utilize inductive coils to generate a magnetic field that is used to charge a device. Users typically must place the device at a specific position on the charging pad and are unable to move the device to different positions on the pad, without interrupting or terminating the charging of the device. This results in a frustrating experience for many users as they may be unable to locate the device at the exact right position on the pad in which to start charging their device. Often, users may think that their device has been properly positioned, but may then dishearteningly find hours later that very little (or no) energy has been transferred.

### SUMMARY

Accordingly, there is a need for wireless charging systems (e.g., RF charging pads) and associated antennas that address the problems identified above, in particular to help ensure a high percentage of energy transfer efficiency (e.g., greater than 80%, such as 90%) when transmitting and receiving antennas are misaligned, which helps to ensure that users are able to place their devices at a variety of different positions and still have those devices be charged efficiently and wirelessly.

In one aspect, an RF charging pad is described herein that includes components that are efficiently arranged on a single integrated circuit, and that single integrated circuit manages antennas of the RF charging pad by selectively or sequentially activating antenna zones (e.g., one or more antennas or unit cell antennas of the RF charging pad that are grouped together, also referred to herein as an antenna group) to locate an efficient antenna zone to use for transmission of wireless power to a receiver device that is located on a surface of the RF charging pad. Such systems and methods of use thereof help to eliminate user dissatisfaction with conventional charging pads. For example, by monitoring transferred energy while selectively activating the antenna zones, such systems and methods of use thereof help to eliminate wasted RF power transmissions by ensuring that energy transfer is maximized at any point in time and at any position at which a device may be placed on an RF charging pad, thus eliminating wasteful transmissions that may not be efficiently received.

In the description that follows, references are made to an RF charging pad that includes various antenna zones. For the purposes of this description, antenna zones include one or more transmitting antennas of the RF charging pad, and each antenna zone may be individually addressable by a controlling integrated circuit (e.g., RF power transmitter integrated circuit 160, FIGS. 1A-1B) to allow for selective activation of each antenna zone in order to determine which antenna zone is able to most efficiently transfer wireless power to a receiver. The RF charging pad is also inter-changeably referred to herein as a near-field charging pad, or, more simply, as a charging pad.

The RF power transmitter integrated circuit 160 can also be used to control wireless transmission of power via the asymmetric spiral antennas described herein (e.g., in reference to FIGS. 3A-8B).

To help address the problems described above and to thereby provide charging pads that satisfy user needs, the antenna zones described above may include adaptive antenna elements (e.g., antenna zones 290 of the RF charging pad 100, FIG. 1B, may each respectively include one or more of the antennas described below in reference to FIGS. 3A-8B) that are able to allow for mobility in placement of user's devices that are to receive a wireless charge, so that transmitting and receiving antennas are able to achieve high energy transfer percentages even when the antennas are misaligned, which allows for charging a device that is placed at any position on a charging pad.
(A1) In some embodiments, a near-field charging system for wirelessly charging electronic devices using electromagnetic energy having a low frequency is provided. The near-field charging system includes: a transmitting antenna with a first substrate; and a first antenna, coupled to the first substrate, that follows a first meandering pattern having a first length, and the transmitting antenna has a first port impedance. The near-field charging system also includes a receiving antenna comprising: a second substrate; and a second antenna, coupled to the second substrate, that follows a second meandering pattern having a second length, and (i) the second length is less than the first length, and (ii) the receiving antenna has a second port impedance that is less than the first port impedance. Also, the transmitting antenna is configured to transmit electromagnetic energy having a frequency at or below 60 MHz to the receiving antenna at an efficiency above 90%, and the receiving antenna is coupled to power-conversion circuitry for converting the electromagnetic energy into usable power for charging or powering an electronic device that is coupled to the receiving antenna and the power-conversion circuitry.
(A2) In some embodiments of the system of A1, the first meandering pattern is a first spiral pattern with a first number of revolutions; and the second meandering pattern is a second spiral pattern with a second number of revolutions, the second number of revolutions being less than the first number of revolutions.
(A3) In some embodiments of the system of A2, the first spiral pattern is a planar rectangular spiral; and the second spiral pattern is a planar rectangular spiral.
(A4) In some embodiments of the system of any of A1-A3, the transmitting antenna further comprises a first via configured to feed radio frequency (RF) signals to the first antenna; and the receiving antenna further comprises a second via configured to transfer energy harvested by the second antenna to the power-conversion circuitry.
(A5) In some embodiments of the system of A4, the first via is positioned at a center of the first substrate; and the second via is offset in at least one direction from a center of the second substrate.
(A6) In some embodiments of the system of any of A1-A5, the first substrate has a first thickness; and the second substrate has a second thickness that is less than the first thickness.
(A7) In some embodiments of the system of any of A1-A6, the first antenna has a first width; and the second antenna has a second width that is greater than the first width.
(A8) In some embodiments of the system of A7, the first antenna comprises a first plurality of antenna elements; and at least one antenna element of the first plurality of antenna elements has a third width that is less than the first width.
(A9) In some embodiments of the system of A8, the second antenna comprises a second plurality of antenna elements; and at least one antenna element of the second plurality of antenna elements has a fourth width that is less than the second width and greater than the third width.
(A10) In some embodiments of the system of any of A1-A9, the transmitting antenna is configured to transmit electromagnetic energy having a frequency between 30 MHz and 50 MHz.
(A11) In some embodiments of the system of A10, the transmitting antenna is configured to transmit electromagnetic energy having a frequency at 40 MHz.
(A12) In some embodiments of the system of any of A1-A10, the transmitting antenna includes a first via; the receiving antenna includes a second via; and when the transmitting antenna is aligned with the receiving antenna, the first via and the second via are axially misaligned.
(A13) In some embodiments of the system of any of A1-A10, the transmitting antenna has a port impedance of approximately 50 ohms, and the receiving antenna has a port impedance of approximately 5 ohms.

(A14) In another aspect, a near-field charging system for wirelessly charging electronic devices using electromagnetic energy having a low frequency is provided. The near-field charging system includes: a transmitting antenna having a first antenna that follows a first meandering pattern; and a receiving antenna having a second antenna that follows a second meandering pattern, whereby the second meandering pattern is different from the first meandering pattern. Also, the transmitting antenna is configured to transmit electromagnetic energy having a frequency at or below 60 MHz to the receiving antenna at an efficiency above 90%, and the receiving antenna is coupled to power-conversion circuitry for converting the electromagnetic energy into usable power for charging or powering an electronic device that is coupled to the receiving antenna and the power-conversion circuitry.
(A15) In some embodiments of the system of A14, the system is further configured in accordance with any of A2-A13.
(A16) In a further aspect, a wireless power receiver for wirelessly charging electronic devices using electromagnetic energy having a low frequency is provided. The receiver includes a receiving antenna with an antenna, coupled to a substrate, that follows a meandering pattern having a length, and: (i) the length of the antenna is less than a length of an antenna of a transmitting antenna, and (ii) the receiving antenna has a port impedance that is less than a port impedance of the transmitting antenna. Also, the transmitting antenna is configured to transmit electromagnetic energy having a frequency at or below 60 MHz to the receiving antenna at an efficiency above 90%, and the receiving antenna is coupled to power-conversion circuitry for converting the electromagnetic energy into usable power for powering an electronic device that is coupled to the power-conversion circuitry.
(A17) In some embodiments of the receiver of A16, the receiver is further configured in accordance with the features of receivers described in any of A2-A13.
(A18) In an additional aspect, a wireless power transmitter for wirelessly charging electronic devices using electromagnetic energy having a low frequency is provided. The transmitter includes: a transmitting antenna with an antenna, coupled to a substrate, that follows a meandering pattern having a length, and: (i) the length of the antenna is greater than a length of an antenna of a receiving antenna, and (ii) the receiving antenna has a port impedance that is less than a port impedance of the transmitting antenna. Also, the transmitting antenna is configured to transmit electromagnetic energy having a frequency at or below 60 MHz to the receiving antenna at an efficiency above 90%, and the receiving antenna is coupled to power-conversion circuitry for converting the electromagnetic energy into usable power for powering an electronic device that is coupled to the power-conversion circuitry.
(A19) In some embodiments of the transmitter of A18, the receiver is further configured in accordance with the features of transmitters described in any of A2-A13.

Thus, wireless charging systems, including the antennas described above, configured in accordance with the principles described herein are able to charge an electronic device that is placed at any position on an RF charging pad.

In addition, wireless charging systems configured in accordance with the principles described herein are able to charge different electronic devices that are tuned at different frequencies or frequency bands on the same charging transmitter. In some embodiments, a transmitter with a single antenna element can operate at multiple frequencies or frequency bands at the same time or at different times. In some embodiments, a transmitter with multiple antenna elements can operate at multiple frequencies or frequency bands at the same time. That enables more flexibility in the types and sizes of antennas that are included in receiving devices.

As described above, there is also a need for an integrated circuit that includes components for managing transmission of wireless power that are all integrated on a single integrated circuit. Such a integrated circuit and methods of use thereof help to eliminate user dissatisfaction with conventional charging pads. By including all components on a single chip (as discussed in more detail below in reference to FIGS. 1A and 1B), such integrated circuits are able to manage operations at the integrated circuits more efficiently and quickly (and with lower latency), thereby helping to improve user satisfaction with the charging pads that are managed by these integrated circuits.
(B1) In some embodiments, an integrated circuit includes: (i) a processing unit that is configured to control operation of the integrated circuit, (ii) a power converter, operatively coupled to the processing unit, that is configured to convert an input current into radio frequency energy, (iii) a waveform generator, operatively coupled to the processing unit, that is configured to generate a plurality of power transmission signals using the radio frequency energy, (iv) a first interface that couples the integrated circuit with a plurality of power amplifiers that are external to the integrated circuit, and (v) a second interface, distinct from the first interface, that couples the integrated circuit with a wireless communication component. The processing unit is also configured to: (i) receive, via the second interface, an indication that a wireless power receiver is within transmission range of a near-field charging pad controlled by the integrated circuit, and (ii) in response to receiving the indication provide, via the first interface, at least some of the plurality of power transmission signals to at least one of the plurality of power amplifiers.
(B2) In some embodiments of the integrated circuit of B1, the processing unit includes a CPU, ROM, RAM, and encryption (e.g., CPU subsystem 170, FIG. 1B).
(B3) In some embodiments of the integrated circuit of any of B1-B2, the input current is direct current. Alternatively, in some embodiments, the input current is alternating current. In these embodiments, the power converter is a radio frequency DC-DC converter or a radio frequency AC-AC converter, respectively.
(B4) In some embodiments of the integrated circuit of any of B1-B3, the wireless communication component is a Bluetooth or Wi-Fi radio that is configured to receive communication signals from a device that is placed on a surface of the near-field charging pad.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not intended to circumscribe or limit the inventive subject matter.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1A is a block diagram of an RF wireless power transmission system, in accordance with some embodiments.

FIG. 1B is a block diagram showing components of an example RF charging pad that includes an RF power transmitter integrated circuit and antenna zones, in accordance with some embodiments.

FIG. 1C is a block diagram showing components of an example RF charging pad that includes an RF power transmitter integrated circuit coupled to a switch, in accordance with some embodiments.

FIG. 2A is a block diagram illustrating an example RF charging pad, in accordance with some embodiments.

FIG. 2B is a block diagram illustrating an example receiver device, in accordance with some embodiments.

FIGS. 3A to 5B show various views of an example near-field power transfer system in accordance with some embodiments.

FIG. 6 shows one example of an electronic device, with a receiving antenna integrated therein, positioned on a transmitted pad, having a transmitting antenna integrated therein.

FIG. 7 is a block diagram illustrating an interaction between a transmitting antenna and a receiving antenna in accordance with some embodiments.

FIGS. 8A and 8B show energy transfer efficiencies of a receiving antenna and transmitting antenna.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

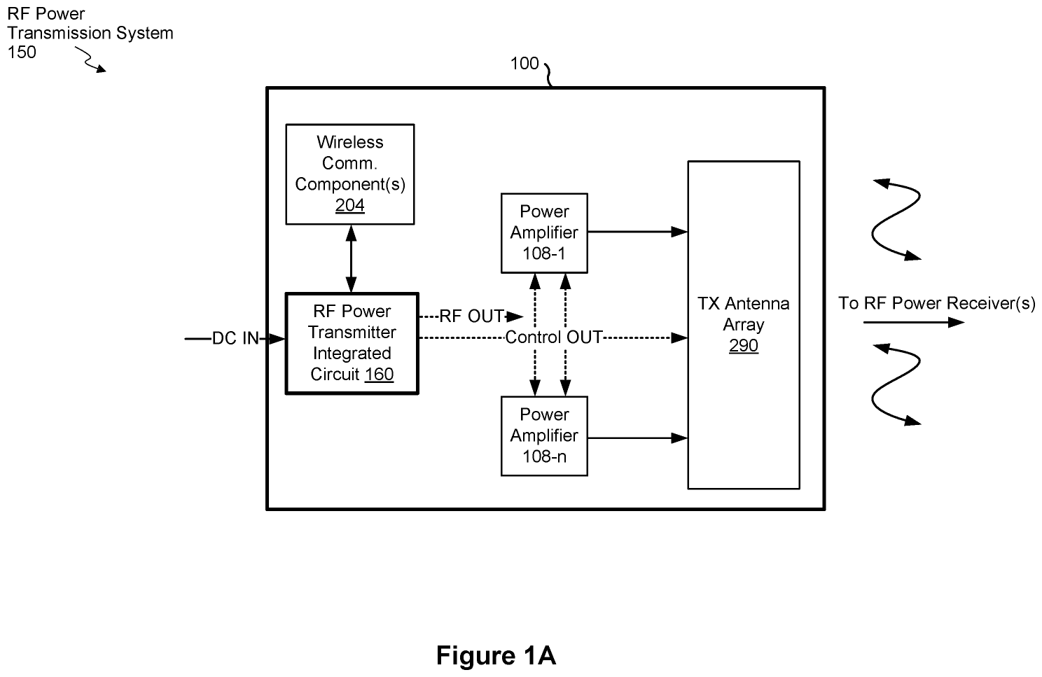

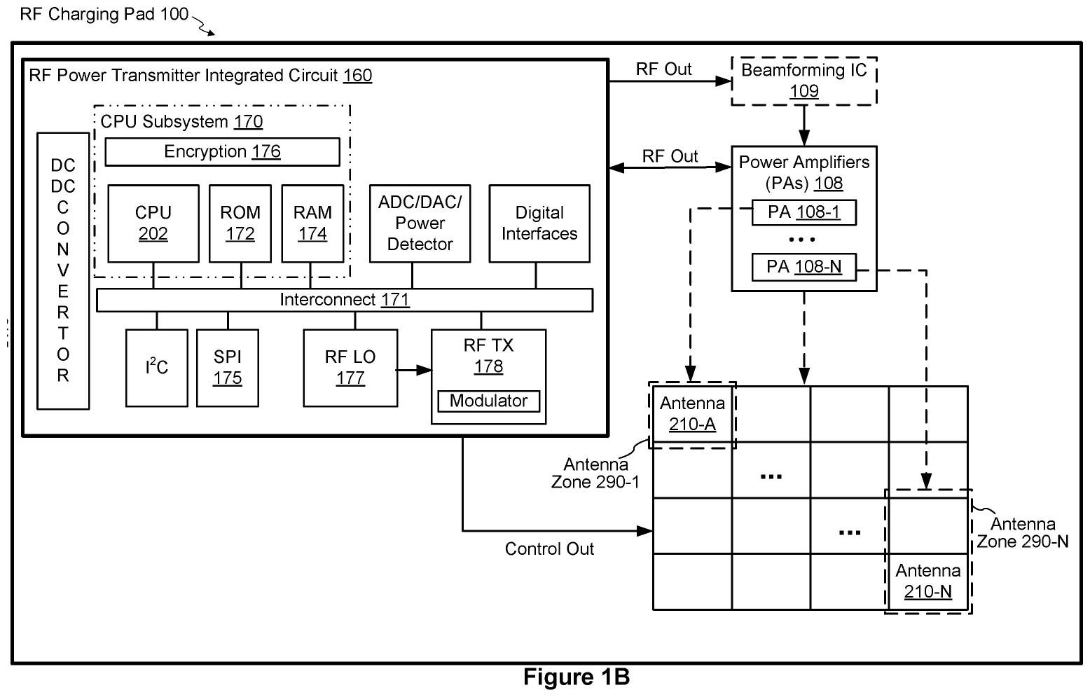

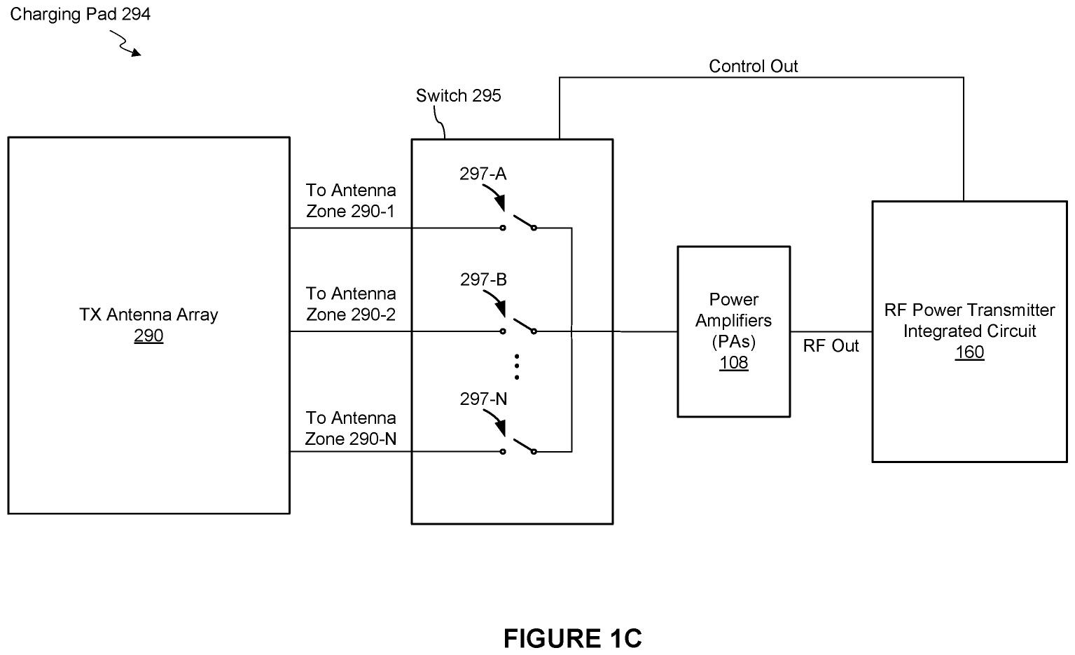

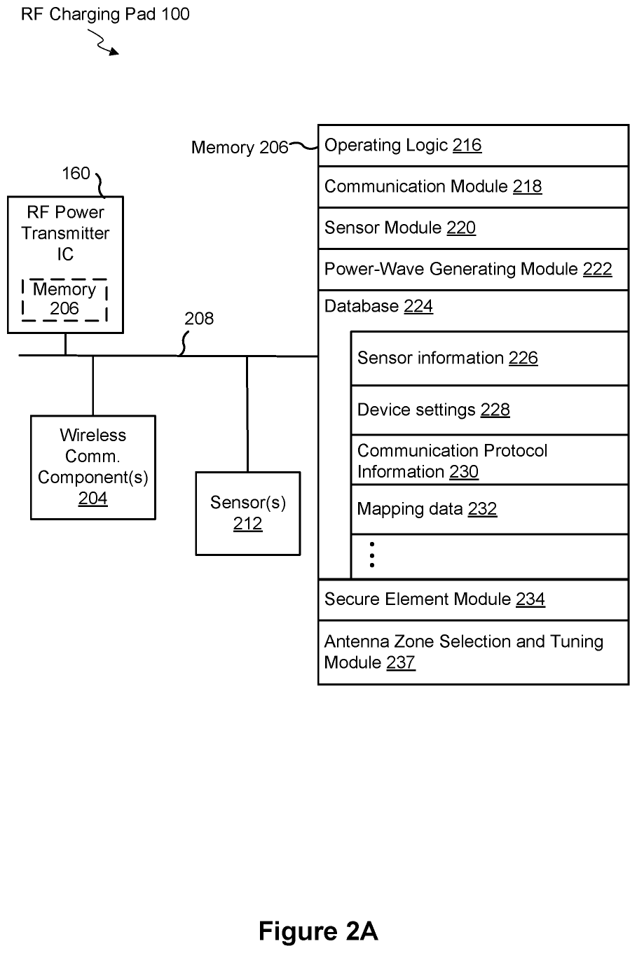

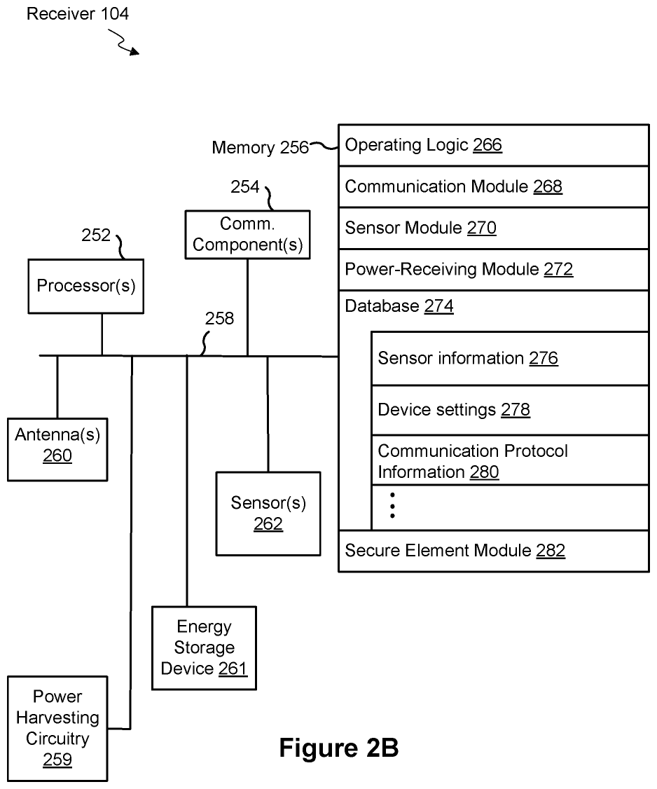

FIG. 1A is a block diagram of an RF wireless power transmission system in accordance with some embodiments. In some embodiments, the RF wireless power transmission system 150 includes a RF charging pad 100 (also referred to herein as a near-field (NF) charging pad 100 or RF charging pad 100). In some embodiments, the RF charging pad 100 includes an RF power transmitter integrated circuit 160 (described in more detail below). In some embodiments, the RF charging pad 100 includes one or more communications components 204 (e.g., wireless communication components, such as WI-FI or BLUETOOTH radios), discussed in more detail below with reference to FIG. 2A. In some embodiments, the RF charging pad 100 also connects to one or more power amplifier units 108-1, . . . 108-n to control operation of the one or more power amplifier units when they drive an external TX antenna array 210. In some embodiments, RF power is controlled and modulated at the RF charging pad 100 via switch circuitry as to enable the RF wireless power transmission system to send RF power to one or more wireless receiving devices via the TX antenna array 210.

In some embodiments, the communication component(s) 204 enable communication between the RF charging pad 100 and one or more communication networks. In some embodiments, the communication component(s) 204 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document.

FIG. 1B is a block diagram of the RF power transmitter integrated circuit 160 (the “integrated circuit”) in accordance with some embodiments. In some embodiments, the integrated circuit 160 includes a CPU subsystem 170, an external device control interface, an RF subsection for DC to RF power conversion, and analog and digital control interfaces interconnected via an interconnection component, such as a bus or interconnection fabric block 171. In some embodiments, the CPU subsystem 170 includes a microprocessor unit (CPU) 202 with related Read-Only-Memory (ROM) 172 for device program booting via a digital control interface, e.g. an I²C port, to an external FLASH containing the CPU executable code to be loaded into the CPU Subsystem Random Access Memory (RAM) 174 (e.g., memory 206, FIG. 2A) or executed directly from FLASH. In some embodiments, the CPU subsystem 170 also includes an encryption module or block 176 to authenticate and secure communication exchanges with external devices, such as wireless power receivers that attempt to receive wirelessly delivered power from the RF charging pad 100.

In some embodiments, executable instructions running on the CPU (such as those shown in the memory 206 in FIG. 2A and described below) are used to manage operation of the RF charging pad 100 and to control external devices through a control interface, e.g., SPI control interface 175, and the other analog and digital interfaces included in the RF power transmitter integrated circuit 160. In some embodiments, the CPU subsystem also manages operation of the RF subsection of the RF power transmitter integrated circuit 160, which includes an RF local oscillator (LO) 177 and an RF transmitter (TX) 178. In some embodiments, the RF LO 177 is adjusted based on instructions from the CPU subsystem 170 and is thereby set to different desired frequencies of operation, while the RF TX converts, amplifies, modulates the RF output as desired to generate a viable RF power level.

In some embodiments, the RF power transmitter integrated circuit 160 provides the viable RF power level (e.g., via the RF TX 178) to an optional beamforming integrated circuit (IC) 109, which then provides phase-shifted signals to one or more power amplifiers 108. In some embodiments, the beamforming IC 109 is used to ensure that power transmission signals sent using two or more antennas 210 (e.g., each antenna 210 may be associated with a different antenna zones 290 or may each belong to a single antenna zone 290) to a particular wireless power receiver are transmitted with appropriate characteristics (e.g., phases) to ensure that power transmitted to the particular wireless power receiver is maximized (e.g., the power transmission signals arrive in phase at the particular wireless power receiver). In some embodiments, the beamforming IC 109 forms part of the RF power transmitter IC 160.

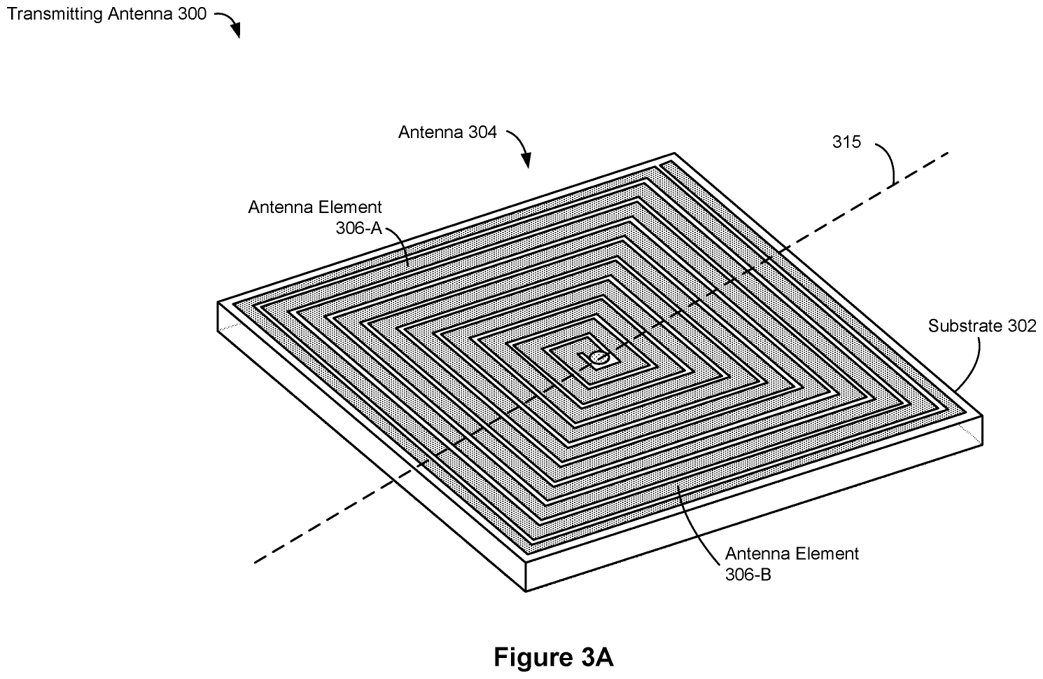

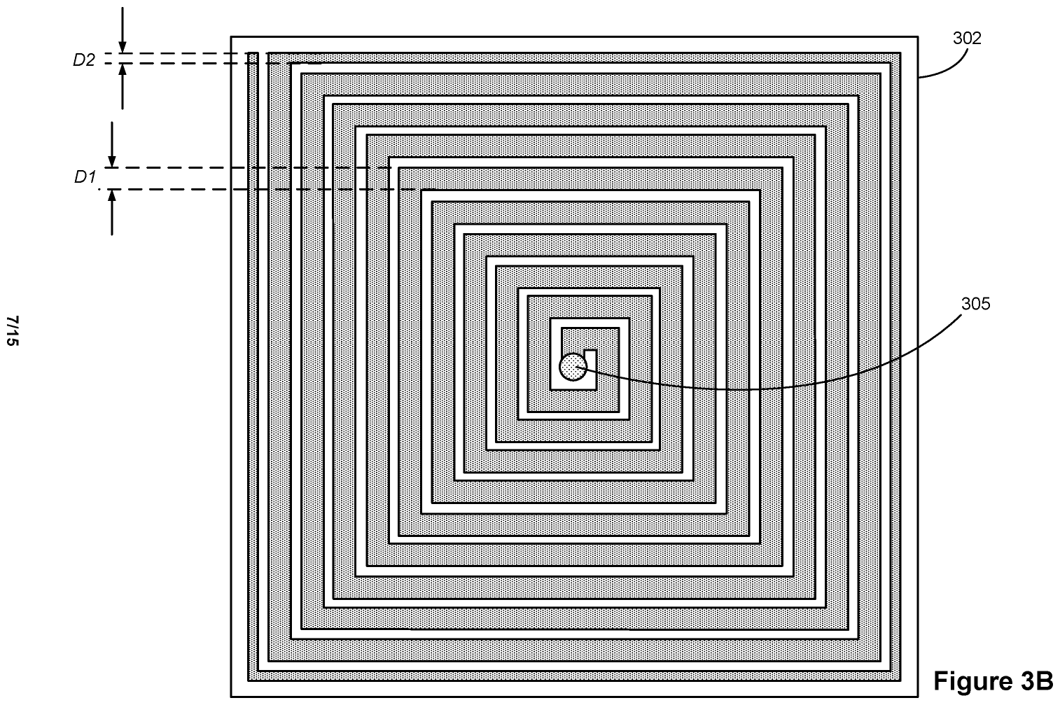

The antennas 210 can be any of the transmitting antennas 300 described below with reference to FIGS. 3A-8B.

In some embodiments, the RF power transmitter integrated circuit 160 provides the viable RF power level (e.g., via the RF TX 178) directly to the one or more power amplifiers 108 and does not use the beamforming IC 109 (or bypasses the beamforming IC if phase-shifting is not required, such as when only a single antenna 210 is used to transmit power transmission signals to a wireless power receiver).

In some embodiments, the one or more power amplifiers 108 then provide RF signals to the antenna zones 290 for transmission to wireless power receivers that are authorized to receive wirelessly delivered power from the RF charging pad 100. In some embodiments, each antenna zone 290 is coupled with a respective PA 108 (e.g., antenna zone 290-1 is coupled with PA 108-1 and antenna zone 290-N is coupled with PA 108-N). In some embodiments, multiple antenna zones are each coupled with a same set of PAs 108 (e.g., all PAs 108 are coupled with each antenna zone 290). Various arrangements and couplings of PAs 108 to antenna zones 290 allow the RF charging pad 100 to sequentially or selectively activate different antenna zones in order to determine the most efficient antenna zone 290 to use for transmitting wireless power to a wireless power receiver. In some embodiments, the one or more power amplifiers 108 are also in communication with the CPU subsystem 170 to allow the CPU 202 to measure output power provided by the PAs 108 to the antenna zones of the RF charging pad 100.

FIG. 1B also shows that, in some embodiments, the antenna zones 290 of the RF charging pad 100 may include one or more antennas 210A-N. In some embodiments, each antenna zones of the plurality of antenna zones includes one or more antennas 210 (e.g., antenna zone 290-1 includes one antenna 210-A and antenna zones 290-N includes multiple antennas 210). In some embodiments, a number of antennas included in each of the antenna zones is dynamically defined based on various parameters, such as a location of a wireless power receiver on the RF charging pad 100. In some embodiments, the antenna zones may include one or more of the meandering line antennas described in more detail below. In some embodiments, each antenna zone 290 may include antennas of different types (e.g., a meandering line antenna and a loop antenna), while in other embodiments each antenna zone 290 may include a single antenna of a same type (e.g., all antenna zones 290 include one meandering line antenna), while in still other embodiments, the antennas zones may include some antenna zones that include a single antenna of a same type and some antenna zones that include antennas of different types. Antenna zones are also described in further detail below.

In some embodiments, the RF charging pad 100 may also include a temperature monitoring circuit that is in communication with the CPU subsystem 170 to ensure that the RF charging pad 100 remains within an acceptable temperature range. For example, if a determination is made that the RF charging pad 100 has reached a threshold temperature, then operation of the RF charging pad 100 may be temporarily suspended until the RF charging pad 100 falls below the threshold temperature.

By including the components shown for RF power transmitter circuit 160 (FIG. 1B) on a single chip, such integrated circuits are able to manage operations at the integrated circuits more efficiently and quickly (and with lower latency), thereby helping to improve user satisfaction with the charging pads that are managed by these integrated circuits. For example, the RF power transmitter circuit 160 is cheaper to construct, has a smaller physical footprint, and is simpler to install. Furthermore, and as explained in more detail below in reference to FIG. 2A, the RF power transmitter circuit 160 may also include a secure element module 234 (e.g., included in the encryption block 176 shown in FIG. 1B) that is used in conjunction with a secure element module 282 (FIG. 2B) or a receiver 104 to ensure that only authorized receivers are able to receive wirelessly delivered power from the RF charging pad 100 (FIG. 1B).

FIG. 1C is a block diagram of a charging pad 294 in accordance with some embodiments. The charging pad 294 is an example of the charging pad 100 (FIG. 1A), however, one or more components included in the charging pad 100 are not included in the charging pad 294 for case of discussion and illustration.

The charging pad 294 includes an RF power transmitter integrated circuit 160, one or more power amplifiers 108, and a transmitter antenna array 290 having multiple antenna zones. Each of these components is described in detail above with reference to FIGS. 1A and 1B. Additionally, the charging pad 294 includes a switch 295, positioned between the power amplifiers 108 and the antenna array 290, having a plurality of switches 297-A, 297-B, . . . 297-N. The switch 295 is configured to switchably connect one or more power amplifiers 108 with one or more antenna zones of the antenna array 290 in response to control signals provided by the RF power transmitter integrated circuit 160.

To accomplish the above, each switch 297 is coupled with (e.g., provides a signal pathway to) a different antenna zone of the antenna array 290. For example, switch 297-A may be coupled with a first antenna zone 290-1 (FIG. 1B) of the antenna array 290, switch 297-B may be coupled with a second antenna zone 290-2 of the antenna array 290, and so on. Each of the plurality of switches 297-A, 297-B, . . . 297-N, once closed, creates a unique pathway between a respective power amplifier 108 (or multiple power amplifiers 108) and a respective antenna zone of the antenna array 290. Each unique pathway through the switch 295 is used to selectively provide RF signals to specific antenna zones of the antenna array 290. It is noted that two or more of the plurality of switches 297-A, 297-B, . . . 297-N may be closed at the same time, thereby creating multiple unique pathways to the antenna array 290 that may be used simultaneously.

In some embodiments, the RF power transmitter integrated circuit 160 is coupled to the switch 295 and is configured to control operation of the plurality of switches 297-A, 297-B, . . . 297-N (illustrated as a “control out” signal in FIGS. 1A and IC). For example, the RF power transmitter integrated circuit 160 may close a first switch 297-A while keeping the other switches open. In another example, the RF power transmitter integrated circuit 160 may close a first switch 297-A and a second switch 297-B, and keep the other switches open (various other combinations and configuration are possible). Moreover, the RF power transmitter integrated circuit 160 is coupled to the one or more power amplifiers 108 and is configured to generate a suitable RF signal (e.g., the “RF Out” signal) and provide the RF signal to the one or more power amplifiers 108. The one or more power amplifiers 108, in turn, are configured to provide the RF signal to one or more antenna zones of the antenna array 290 via the switch 295, depending on which switches 297 in the switch 295 are closed by the RF power transmitter integrated circuit 160.

To further illustrate, the charging pad is configured to transmit test power transmission signals and/or regular power transmission signals using different antenna zones, e.g., depending on a location of a receiver on the charging pad. Accordingly, when a particular antenna zone is selected for transmitting test signals or regular power signals, a control signal is sent to the switch 295 from the RF power transmitter integrated circuit 160 to cause at least one switch 297 to close. In doing so, an RF signal from at least one power amplifier 108 can be provided to the particular antenna zone using a unique pathway created by the now-closed at least one switch 297.

In some embodiments, the switch 295 may be part of (e.g., internal to) the antenna array 290. Alternatively, in some embodiments, the switch 295 is separate from the antenna array 290 (e.g., the switch 295 may be a distinct component, or may be part of another component, such as the power amplifier(s) 108). It is noted that any switch design capable of accomplishing the above may be used, and the design of the switch 295 illustrated in Figure IC is merely one example.

FIG. 2A is a block diagram illustrating certain components of an RF charging pad 100 in accordance with some embodiments. In some embodiments, the RF charging pad 100 includes an RF power transmitter IC 160 (and the components included therein, such as those described above in reference to FIGS. 1A-1B), memory 206 (which may be included as part of the RF power transmitter IC 160, such as nonvolatile memory 206 that is part of the CPU subsystem 170), and one or more communication buses 208 for interconnecting these components (sometimes called a chipset). In some embodiments, the RF charging pad 100 includes one or more sensor(s) 212 (discussed below). In some embodiments, the RF charging pad 100 includes one or more output devices such as one or more indicator lights, a sound card, a speaker, a small display for displaying textual information and error codes, etc. In some embodiments, the RF charging pad 100 includes a location detection device, such as a GPS (global positioning satellite) or other geo-location receiver, for determining the location of the RF charging pad 100.

In some embodiments, the one or more sensor(s) 212 include one or more thermal radiation sensors, ambient temperature sensors, humidity sensors, IR sensors, occupancy sensors (e.g., RFID sensors), ambient light sensors, motion detectors, accelerometers, and/or gyroscopes.

The memory 206 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 206, or alternatively the non-volatile memory within memory 206, includes a non-transitory computer-readable storage medium. In some embodiments, the memory 206, or the non-transitory computer-readable storage medium of the memory 206, stores the following programs, modules, and data structures, or a subset or superset thereof:
Operating logic 216 including procedures for handling various basic system services and for performing hardware dependent tasks;
Communication module 218 for coupling to and/or communicating with remote devices (e.g., remote sensors, transmitters, receivers, servers, mapping memories, etc.) in conjunction with wireless communication component(s) 204;
Sensor module 220 for obtaining and processing sensor data (e.g., in conjunction with sensor(s) 212) to, for example, determine the presence, velocity, and/or positioning of object in the vicinity of the RF charging pad 100;
Power-wave generating module 222 for generating and transmitting power transmission signals (e.g., in conjunction with antenna zones 290 and the antennas 210 respectively included therein), including but not limited to, forming pocket(s) of energy at given locations. Power-wave generating module 222 may also be used to modify transmission characteristics used to transmit power transmission signals by individual antenna zones; and
Database 224, including but not limited to:
   Sensor information 226 for storing and managing data received, detected, and/or transmitted by one or more sensors (e.g., sensors 212 and/or one or more remote sensors);
   Device settings 228 for storing operational settings for the RF charging pad 100 and/or one or more remote devices;
   Communication protocol information 230 for storing and managing protocol information for one or more protocols (e.g., custom or standard wireless protocols, such as ZigBee, Z-Wave, etc., and/or custom or standard wired protocols, such as Ethernet); and
   Mapping data 232 for storing and managing mapping data (e.g., mapping one or more transmission fields);
a secure element module 234 for determining whether a wireless power receiver is authorized to receive wirelessly delivered power from the RF charging pad 100; and
an antenna zone selecting and tuning module 237 for coordinating a process of transmitting test power transmission signals with various antenna zones to determine which antenna zone or zones should be used to wirelessly deliver power to various wireless power receivers.

Each of the above-identified elements (e.g., modules stored in memory 206 of the RF charging pad 100) is optionally stored in one or more of the previously mentioned memory devices, and corresponds to a set of instructions for performing the function(s) described above. The above identified modules or programs (e.g., sets of instructions) need not be implemented as separate software programs, procedures, or modules, and thus various subsets of these modules are optionally combined or otherwise rearranged in various embodiments. In some embodiments, the memory 206, optionally, stores a subset of the modules and data structures identified above.

FIG. 2B is a block diagram illustrating a representative receiver device 104 (also sometimes called a receiver, power receiver, or wireless power receiver) in accordance with some embodiments. In some embodiments, the receiver device 104 includes one or more processing units (e.g., CPUs, ASICs, FPGAs, microprocessors, and the like) 252, one or more communication components 254, memory 256, antenna(s) 260, power harvesting circuitry 259, and one or more communication buses 258 for interconnecting these components (sometimes called a chipset). In some embodiments, the receiver device 104 includes one or more sensor(s) 262 such as the one or sensors 212 described above with reference to FIG. 2A. In some embodiments, the receiver device 104 includes an energy storage device 261 for storing energy harvested via the power harvesting circuitry 259. In various embodiments, the energy storage device 261 includes one or more batteries, one or more capacitors, one or more inductors, and the like.

In some embodiments, the power harvesting circuitry 259 includes one or more rectifying circuits and/or one or more power converters. In some embodiments, the power harvesting circuitry 259 includes one or more components (e.g., a power converter) configured to convert energy from power waves and/or energy pockets to electrical energy (e.g., electricity). In some embodiments, the power harvesting circuitry 259 is further configured to supply power to a coupled electronic device, such as a laptop or phone. In some embodiments, supplying power to a coupled electronic device include translating electrical energy from an AC form to a DC form (e.g., usable by the electronic device).

In some embodiments, the antenna(s) 260 include one or more of the meandering line antennas that are described in further detail below, e.g., the receiving antennas 400 described below in reference to FIGS. 3A-8B.

In some embodiments, the receiver device 104 includes one or more output devices such as one or more indicator lights, a sound card, a speaker, a small display for displaying textual information and error codes, etc. In some embodiments, the receiver device 104 includes a location detection device, such as a GPS (global positioning satellite) or other geo-location receiver, for determining the location of the receiver device 103.

In various embodiments, the one or more sensor(s) 262 include one or more thermal radiation sensors, ambient temperature sensors, humidity sensors, IR sensors, occupancy sensors (e.g., RFID sensors), ambient light sensors, motion detectors, accelerometers, and/or gyroscopes.

The communication component(s) 254 enable communication between the receiver 104 and one or more communication networks. In some embodiments, the communication component(s) 254 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document.

The communication component(s) 254 include, for example, hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

The memory 256 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 256, or alternatively the non-volatile memory within memory 256, includes a non-transitory computer-readable storage medium. In some embodiments, the memory 256, or the non-transitory computer-readable storage medium of the memory 256, stores the following programs, modules, and data structures, or a subset or superset thereof:
Operating logic 266 including procedures for handling various basic system services and for performing hardware dependent tasks;
Communication module 268 for coupling to and/or communicating with remote devices (e.g., remote sensors, transmitters, receivers, servers, mapping memories, etc.) in conjunction with communication component(s) 254;
Sensor module 270 for obtaining and processing sensor data (e.g., in conjunction with sensor(s) 262) to, for example, determine the presence, velocity, and/or positioning of the receiver 103, a RF charging pad 100, or an object in the vicinity of the receiver 103;
Wireless power-receiving module 272 for receiving (e.g., in conjunction with antenna(s) 260 and/or power harvesting circuitry 259) energy from power waves and/or energy pockets; optionally converting (e.g., in conjunction with power harvesting circuitry 259) the energy (e.g., to direct current); transferring the energy to a coupled electronic device; and optionally storing the energy (e.g., in conjunction with energy storage device 261); and
Database 274, including but not limited to:
   Sensor information 276 for storing and managing data received, detected, and/or transmitted by one or more sensors (e.g., sensors 262 and/or one or more remote sensors);
   Device settings 278 for storing operational settings for the receiver 103, a coupled electronic device, and/or one or more remote devices; and
   Communication protocol information 280 for storing and managing protocol information for one or more protocols (e.g., custom or standard wireless protocols, such as ZigBee, Z-Wave, etc., and/or custom or standard wired protocols, such as Ethernet); and
a secure element module 282 for providing identification information to the RF charging pad 100 (e.g., the RF charging pad 100 uses the identification information to determine if the wireless power receiver 104 is authorized to receive wirelessly delivered power).

Each of the above-identified elements (e.g., modules stored in memory 256 of the receiver 104) is optionally stored in one or more of the previously mentioned memory devices, and corresponds to a set of instructions for performing the function(s) described above. The above identified modules or programs (e.g., sets of instructions) need not be implemented as separate software programs, procedures, or modules, and thus various subsets of these modules are optionally combined or otherwise rearranged in various embodiments. In some embodiments, the memory 256, optionally, stores a subset of the modules and data structures identified above. Furthermore, the memory 256, optionally, stores additional modules and data structures not described above, such as an identifying module for identifying a device type of a connected device (e.g., a device type for an electronic device that is coupled with the receiver 104).

FIGS. 3A through 5B show various views of an example near-field power transfer system. Specifically, FIG. 3A shows a top perspective view of a transmitting antenna 300 used in the example near-field power transfer system. In some embodiments, the transmitting antenna 300 is housed by a housing constructed of a material creating minimal obstructions for electromagnetic waves to pass through. In other embodiments, different portions of the housing may be constructed with materials having different electromagnetic properties such as permeability and permittivity. As one example, a top surface of the housing may allow electromagnetic waves to pass through with minimal obstruction while the sidewalls of the housing may obstruct electromagnetic waves by attenuation, absorption, reflection, or other techniques known in the art.

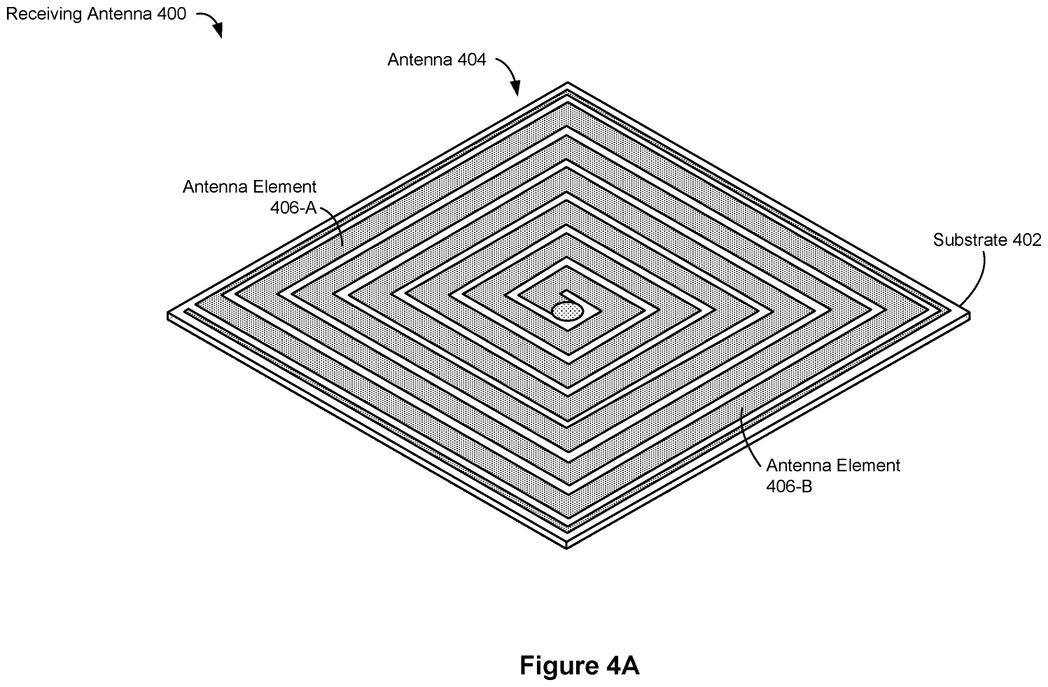

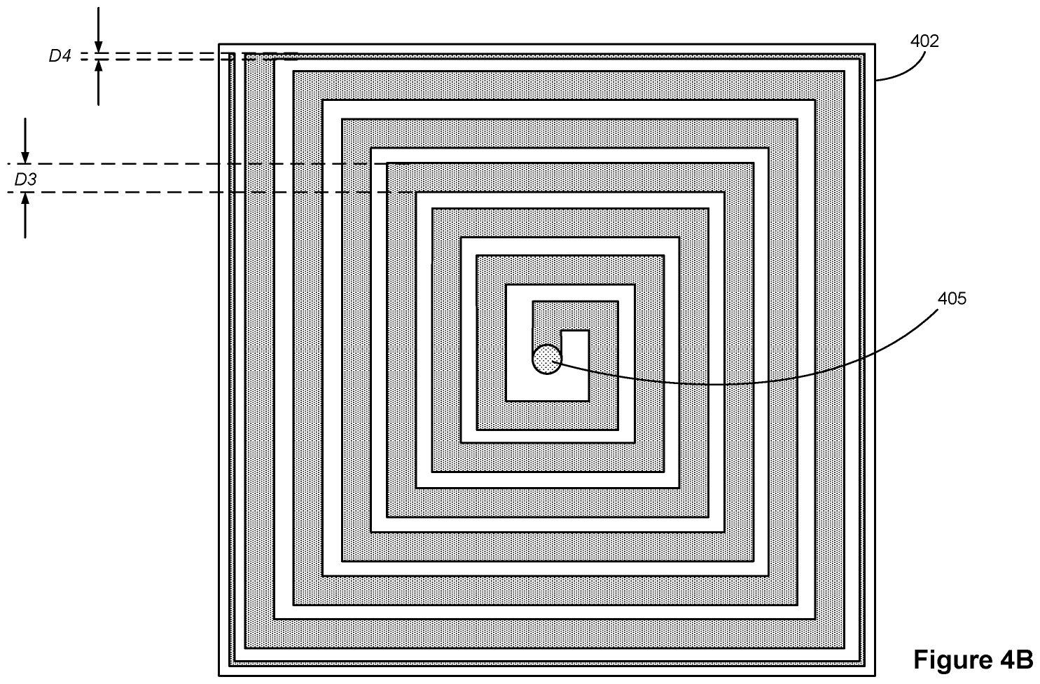

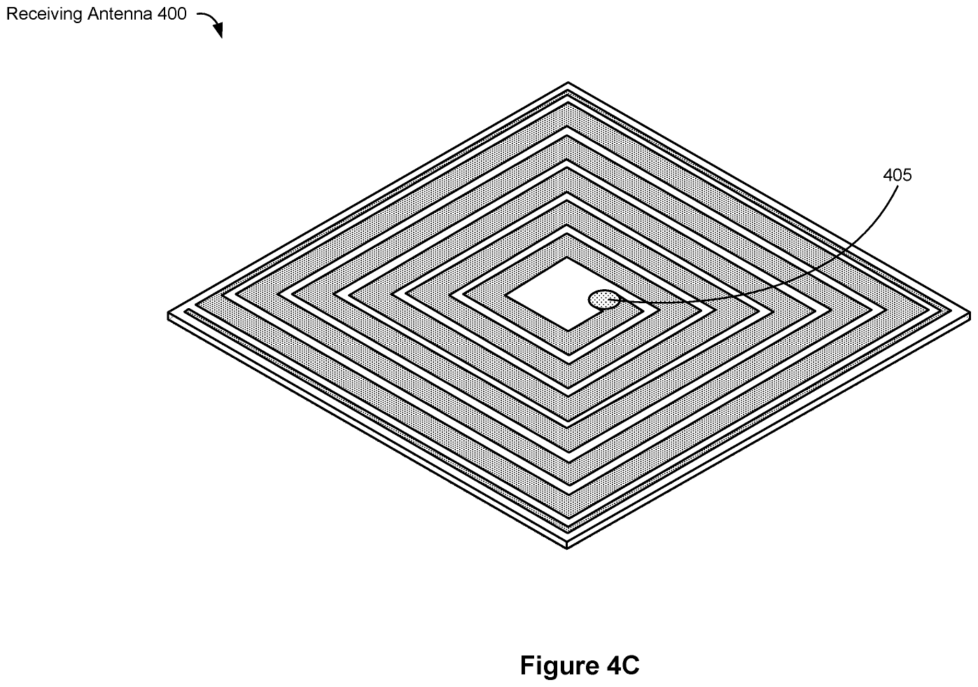

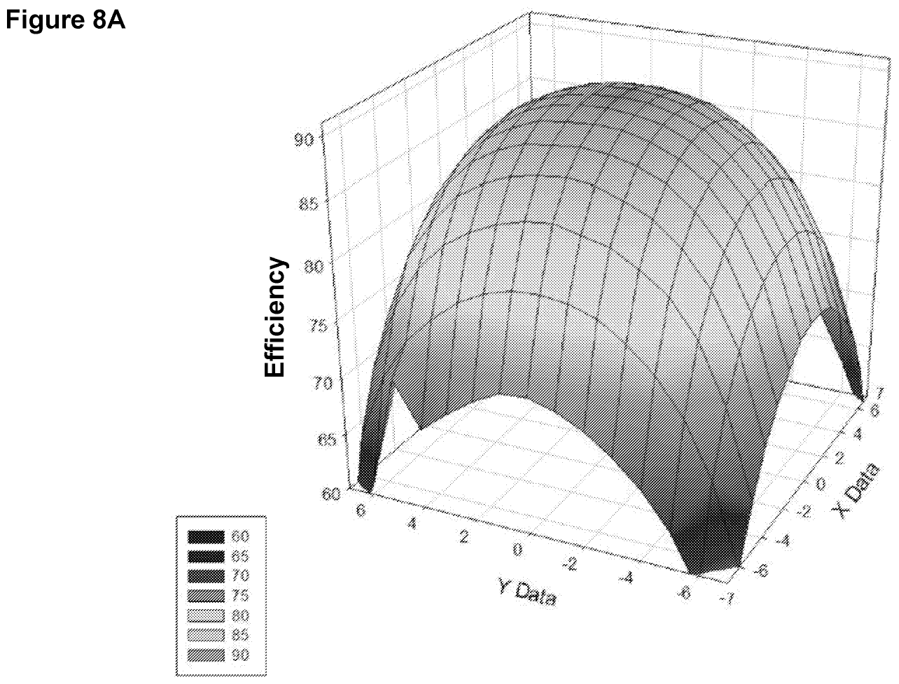

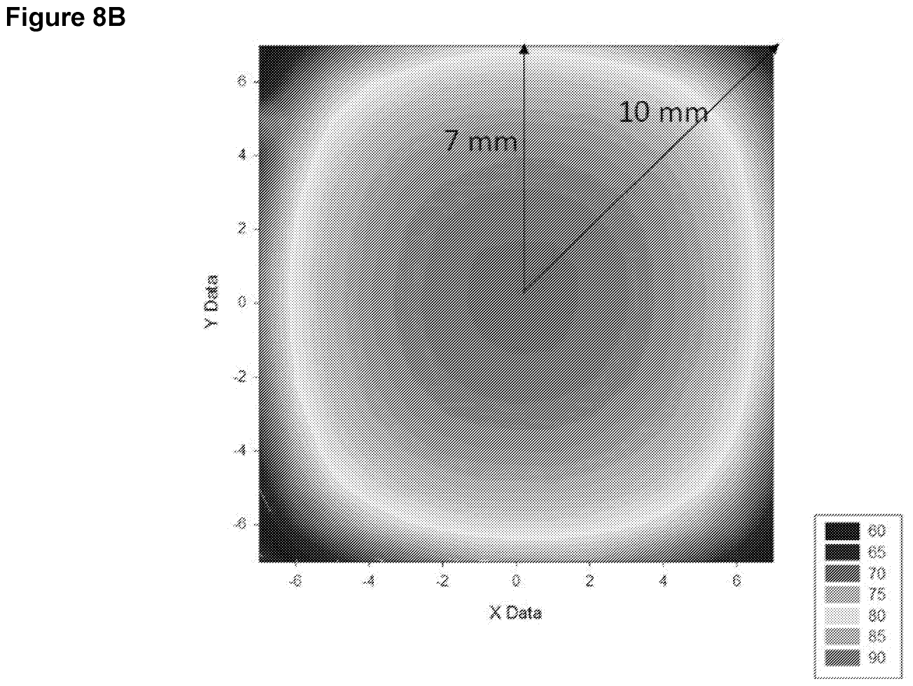

The transmitting antenna 300 is configured to radiate RF energy (e.g., electromagnetic waves/signals), and thus transfer power when adjacent to a receiving antenna 400 (discussed below with reference to FIGS. 4A to 4C). As such, the transmitting antenna 300 may be on a “transmit side,” so as to function as a power transmitter, and the receiving antenna 400 may be on a “receive side,” so as to function as a power receiver. In some embodiments, the transmitting antenna 300 (or subcomponents of the transmitting antenna 300) may be integrated into a transmitter device, or may be externally wired to the transmitter device. As will be discussed in more detail below with reference to FIGS. 8A and 8B, the example near-field power transfer system can achieve an energy transfer efficiency of 90% or higher, despite being configured to operate at low frequencies, such as frequencies below 60 MHz (e.g., 40 MHz).

A substrate 302 may be disposed within a space defined between the top surface, sidewalls, and the bottom surface of the housing. In some embodiments, the transmitting antenna 300 may not include the housing and instead the substrate 302 may include the top surface, sidewalls, and the bottom surface. The substrate 302 may comprise any material capable of insulating, reflecting, absorbing, or otherwise housing electrical lines conducting current, such as metamaterials. The metamaterials may be a broad class of synthetic materials that are engineered to yield desirable magnetic permeability and electrical permittivity. At least one of the magnetic permeability and electrical permittivity may be based upon power-transfer requirements, and/or compliance constraints for government regulations. The metamaterials disclosed herein may receive radiation or may generate radiation, and may act as reflectors.

The transmitting antenna 300 includes an antenna 304 (also referred to herein as a “radiator element,” or a “radiator”). The antenna 304 may be constructed on or below the top surface of the housing (or the substrate 302). The antenna 304 may be used for transmitting electromagnetic waves. The antenna 304 may be constructed from materials such as metals, alloys, metamaterials and composites. For example, the antenna 304 may be made of copper or copper alloys. The antenna 304 may be constructed to have different shapes based on power transfer requirements. For example, in FIGS. 3A and 3B, the antenna 304 is constructed in a shape of a spiral including antenna elements 306 (also referred to herein as “antenna segments”) that are disposed close to each other. In the illustrated embodiment, the antenna 304 includes ten full turns (i.e., ten complete revolutions). It is noted that various turn amounts can be used, so long as the number of turns is greater than the number of turns made by the antenna 404 of the receiving antenna 400. As will be discussed in further detail below, a higher coupling efficiency is achieved by designing the antenna 304 to have more turns than the antenna 404 of the receiving antenna 400 (along with other changes to the design of the antennas 304 and 404, such as width of antenna segments, antenna thickness, location of feeds, and material selection). The spiral shape of the antenna elements 306 is planar, meaning that each revolution of the antenna 304 is on the same plane. Furthermore, while the spiral shape of the antenna elements 306 is rectangular in FIGS. 3A and 3B, the spiral shape may be various other shapes. It is noted that, in some embodiments, the antenna elements 306 (and antenna elements 406) are formed by grounded lines and are much smaller than a wavelength of the transmitted electromagnetic waves.

In some embodiments, a width of antenna elements 306 varies from one turn to the next. Put another way, a surface area of a respective antenna element 306 of the antenna 304 differs from a surface area of at least one other antenna element 306 of the antenna 304. For example, with reference to FIG. 3B, the outer most antenna element 306 of the antenna 304 has a width of D¹, while the other antenna elements of the antenna 304 each has a width of D², which is greater than the width of D¹ (i.e., the outer most revolution of the antenna 304 in thinner than other revolutions of the antenna 304). In some embodiments, each revolution of the antenna 304 may have a different width (e.g., a width of the antenna 304 may progressively increase (or decrease) with each revolution of the antenna 304). Varying the widths of the antenna elements 306 can be used to adjust a surface area of the antenna 306, and in turn, adjust an operating frequency of the antenna 306. In some embodiments, a surface area of each antenna element 306 is optimized according to a design of the antenna 404 of the receiving antenna 400. It is noted that, in some embodiments, the antenna 304 is continuous (e.g., a continuous spiral), while in other embodiments the antenna 304 is composed of contiguous antenna segments 306.

Currents flowing through the antenna elements 306 may be in opposite directions. For example, if the current in antenna element 306-A is flowing from left to right in FIG. 3A, the current in antenna element 306-B (and its adjacent elements) may be flowing from right to left. In some embodiments (e.g., when the transmitting antenna 300 and the receiving antenna 400 are separated from each other by a non-zero distance), since the antenna elements 306 are formed by grounded lines and are much smaller than the wavelength, and due to the opposite flow of current through the transmitting antenna 300, substantially all (e.g., 85%, 90%, 95%, or more) of the electromagnetic radiation in a far-field region of the transmitting antenna 300 gets cancelled. As one example, the far-field electromagnetic radiation generated by one or more antenna elements 306 left of an imaginary line 315 is cancelled out by the far-field electromagnetic radiation generated by one or more antenna elements 306 right of the line 315. In some other embodiments (e.g., when the receiving antenna 400 is positioned on the transmitting antenna), opposite flows of current results in cancellation of a portion of the current (e.g., an undesired portion of the current that should not be transmitted to the receiving antenna 400). In either embodiment, transmission of electromagnetic radiation into the far-field region from the transmitting antenna 300 is substantially eliminated (e.g., 85%, 90%, 95%, or more of all far-field electromagnetic radiation from the transmitting antenna 300 is eliminated). Such cancellation, however, may not occur in a near-field active zone of the transmitting antenna 300, where the transfer of power may occur (e.g., between the transmitting antenna 300 and the receiving antenna 400). Thus, the spiral design of the transmitting antenna 300 facilitates wireless charging using electromagnetic energy, while also minimizing propagation of electromagnetic energy away from a desired charging space (i.e., minimizing propagation of electromagnetic energy into the far field).

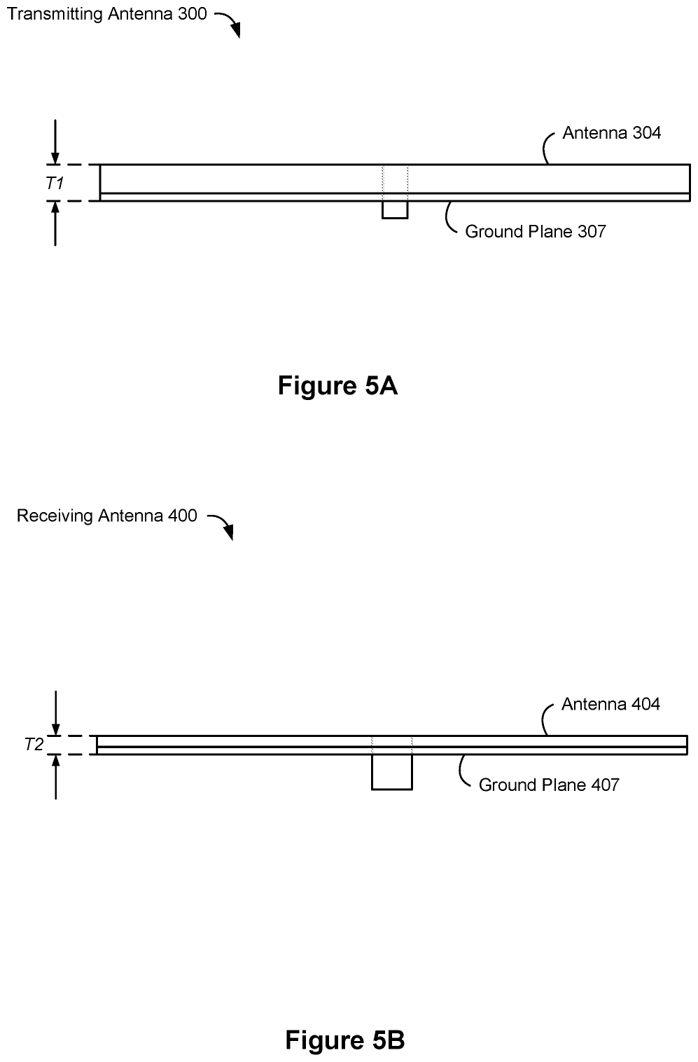

In some embodiments, the transmitting antenna 300 includes a ground plane 307 (shown in FIG. 5A) at or above a bottom surface of the substrate 302. The ground plane 307 may be formed by materials such as metal, alloys, and composites. In an embodiment, the ground plane 307 may be formed by copper or a copper alloy. In some embodiments, the ground plane 307 may be constructed of a solid sheet of material. In other embodiments, the ground plane 307 may be constructed using material strips arranged in shapes such as loops, spirals, and meshes. As shown in FIG. 3B, a via 305 carrying a power feed line (not shown) to the antenna 304 may pass through the ground plane 307. The power feed line may supply current to the antenna 304. In some embodiments, the ground plane 307 may be electrically connected to the antenna 304. In some embodiments, the ground plane 307 may not be electrically connected to the antenna 304. In such embodiments, the via 305 is separated and insulated from the ground plane 307. In some embodiments, the ground plane 307 may act as a reflector of electromagnetic waves generated by the antenna 304. In other words, the ground plane 307 may not allow electromagnetic transmission beyond the bottom surface of the transmitting antenna 300 by cancelling and/or reflecting the transmission image formed beyond the bottom surface. Reflecting electromagnetic waves by the ground plane 307 may reinforce the electromagnetic waves transmitted by the antenna 304 from or towards the top surface of the substrate 302. Therefore, leakage of electromagnetic power from the bottom surface of the substrate 302 is minimized, and in some cases, eliminated. The via 305 may be positioned in a center of the substrate 302 (as shown in FIG. 3B) or the via 305 may be offset from the substrate 302's center in one or more directions.

Due to the arrangement of the antenna 304 and the ground plane 307, electromagnetic waves transmitted by the transmitting antenna 300 accumulate in the near field of the transmitting antenna 300. Importantly (e.g., for compliance with safety regulations governing wireless charging), leakage of electromagnetic energy into the far field is minimized or eliminated.

FIG. 4A shows a top perspective view of a receiving antenna 400 used in the example near-field power transfer system. In some embodiments, the receiving antenna 400 is housed by a housing constructed of a material creating minimal obstructions for electromagnetic waves to pass through. In other embodiments, different portions of the housing may be constructed with materials having different electromagnetic properties such as permeability and permittivity. As one example, a top surface of the housing may allow electromagnetic waves to pass through with minimal obstruction while the sidewalls of the housing may obstruct electromagnetic waves by attenuation, absorption, reflection, or other techniques known in the art.

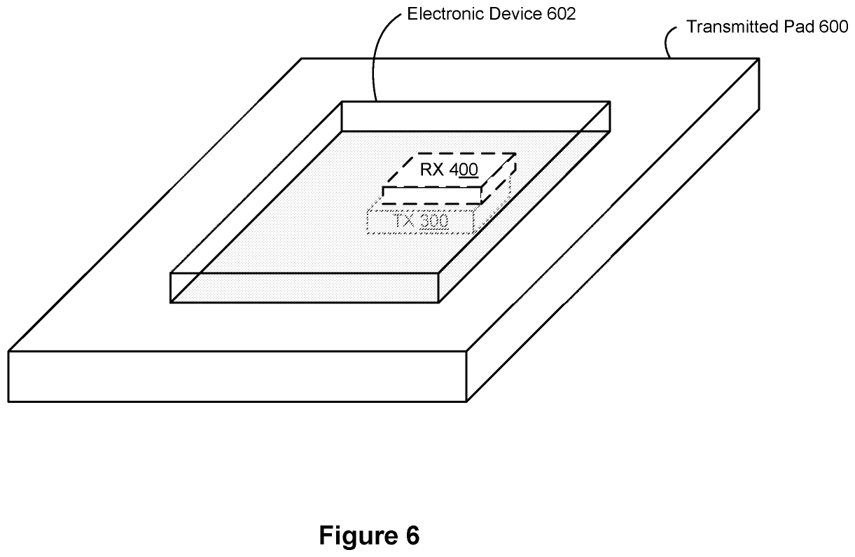

The receiving antenna 400 is configured to receive RF energy (e.g., electromagnetic waves/signals), and thus receive power when adjacent to the transmitting antenna 300 (discussed above with reference to FIGS. 3A and 3B). FIG. 6 shows one example of an electronic device 602, with a receiving antenna 400 integrated therein, positioned on a transmitted pad 600, having a transmitting antenna 300 integrated therein. As shown, the receiving antenna 400 is adjacent to the transmitting antenna 300, and in this arrangement, wireless power transfer occurs with high efficiency (e.g., greater than 90% efficiency). In some embodiments, the receiving antenna 400 (or subcomponents of the receiving antenna 400) may be integrated into a receiver device (e.g., the electronic device 602 shown in FIG. 6), or may be externally wired to the receiver device.

The receiving antenna 400 may include a substrate 402, which can be disposed within a space defined between the top surface, sidewalls, and the bottom surface of the housing. In some embodiments, the receiving antenna 400 may not include the housing and instead the substrate 402 may include the top surface, sidewalls, and the bottom surface. The substrate 402 may comprise any material capable of insulating, reflecting, absorbing, or otherwise housing electrical lines conducting current, such as metamaterials. The metamaterials may be a broad class of synthetic materials that are engineered to yield desirable magnetic permeability and electrical permittivity. At least one of the magnetic permeability and electrical permittivity may be based upon power-transfer requirements, and/or compliance constraints for government regulations. The metamaterials disclosed herein may receive radiation or may generate radiation, and may act as thin reflectors.

The receiving antenna 400 includes an antenna 404 (also referred to herein as a “radiator element,” or a “radiator”). The antenna 404 may be constructed on or below the top surface of the housing (or the substrate 402). As mentioned above, the receiving antenna 400 is associated with power receiving, and thus, the antenna 404 is used for receiving electromagnetic waves. The antenna 404 may be constructed from materials such as metals, alloys, metamaterials and composites. For example, the antenna 404 may be made of copper or copper alloys. The antenna 404 may be constructed to have different shapes based on power transfer requirements. For example, in FIGS. 4A and 4B, the antenna 404 is constructed in a shape of a spiral including antenna elements 406 (also referred to herein as “antenna segments”) that are disposed close to each other. In the illustrated embodiment, the antenna 404 includes six full turns (i.e., six complete revolutions). It is noted that various turn amounts can be used, so long as the number of turns is less than the number of turns made by the antenna 304 of the transmitting antenna 300.

In some embodiments, a width of antenna elements 406 varies from one turn to the next. Put another way, a surface area of a respective antenna element 406 may differ from a surface area of at least one other antenna element 406. For example, with reference to FIG. 4B, the outer most antenna element 406 of the antenna 404 has a width of D⁴, while the other antenna elements each has a width of D³, which is greater than the width of D⁴. In some embodiments, each revolution of the antenna 404 may have a different width (e.g., a width of the antenna 404 may progressively increase (or decrease) with each revolution of the antenna 404). Varying the widths of the antenna elements 406 can be used to adjust a surface area of the antenna 404, and in turn, adjust an operating frequency of the antenna 404. In some embodiments, an arrangement of the antenna elements 406 (e.g., the number of turns) and a surface area of each antenna element 406 are optimized according to a design of the antenna 304 of the transmitting antenna 300. It is noted that, in some embodiments, the antenna 404 is continuous (e.g., a continuous spiral) while in other embodiments the antenna 404 is composed of contiguous antenna segments 406.

Much like the transmitting antenna 300, in some embodiments, the receiving antenna 400 includes a ground plane 407 (shown in FIG. 5B) at or above a bottom surface of the substrate 402. The ground plane 407 may be formed by materials such as metal, alloys, and composites. In some embodiments, the ground plane 407 may be formed by copper or a copper alloy. In some embodiments, the ground plane 407 may be constructed of a solid sheet of material. In other embodiments, the ground plane 407 may be constructed using material strips arranged in shapes such as loops, spirals, and meshes. As shown in FIG. 4B, a via 405 carrying a power feed line (not shown) to the antenna 404 may pass through the ground plane 407. The power feed line may receive current from the antenna 404. In some embodiments, the ground plane 407 may be electrically connected to the antenna 404. In some embodiments, the ground plane 407 may not be electrically connected to the antenna 404. In such embodiments, the via 405 is separated and insulated from the ground plane 407. In some embodiments, the ground plane 407 may act as a reflector. In other words, the ground plane 407 may not allow electromagnetic transmission beyond the bottom surface of the receiving antenna 400 by cancelling and/or reflecting the transmission image formed beyond the bottom surface. Reflecting the electromagnetic waves by the ground plane 407 may reinforce the electromagnetic waves received by the antenna 404.

The via 405 may be positioned in a center of the substrate 402 (as shown in FIG. 4B) or the via 405 may be offset from the substrate 402′s center in one or more directions (as shown in FIG. 4C).

FIG. 4C shows another embodiment of the receiving antenna 400. Specifically, in FIG. 4C, the via 405 is not positioned in a center of the substrate 402. Instead, the via 405 is offset towards one or more of the sides of the substrate 402. In doing so, the via 405 is not coaxially aligned with the via 305 of the transmitting antenna 300, e.g., when the transmitting antenna 300 and the receiving antenna 400 are positioned adjacent each other. The coaxial misalignment between the via 305 and the via 405 can be used to optimize the matching of the antennas in asymmetrical port assignment (i.e. where each antenna is terminated with a different port impedances).

FIGS. 5A and 5B show cross-sectional views of the transmitting antenna 300 and the receiving antenna 400, respectively. As shown in FIG. 5A, the transmitting antenna 300 has a first thickness (T1), which may range from 20 mm to 100 mm. As shown in FIG. 5B, the receiving antenna 400 has a second thickness (T2), which may range from 5 mm to 25 mm, that is less than the first thickness (T1). In one example, the first thickness (T1) is approximately 100 mm while the second thickness (T2) is approximately 10 mm. In another example, the first thickness (T1) is approximately 50 mm while the second thickness (T2) is approximately 20 mm. Various other thicknesses can be used in addition to the examples provided above. In some embodiments, the first thickness (T1) is at least 20% greater than the second thickness (T2). In some embodiments, the first thickness (T1) is between 20-1000% greater than the second thickness (T2). The thickness differences are used to achieve high coupling between the transmitting antenna 300 and the receiving antenna 400 in an asymmetrical system in which each antenna is terminated in a different port impedances (e.g., reducing the thickness of the antenna can help in reducing a port impedance of the receiving antenna 400, relative to a port impedance of the transmitting antenna 300). In some embodiments, the thickness measurements of the transmitting antenna 300 and the receiving antenna 400 include the respective ground planes, while in other embodiments the respective ground planes are omitted from the thickness measurements.

As mentioned above, a higher coupling efficiency is achieved by designing the antenna 304 on the transmitter side to have more turns (i.e., revolutions, loops) than the antenna 404 on the receiver side. Additionally, widths of the antenna 304 (e.g., D¹ and D²) are different from widths of the antenna 404 (e.g., D³ and D⁴) (e.g., widths D³ and D⁴ are greater than widths D¹ and D², respectively). Differences in widths and number of turns can be used to lower a port impedance of the receiving antenna 400. To illustrate, in one example, the transmitting antenna 300 may have a port impedance of approximately 50 ohms, while the receiving antenna 400 may have a port impedance of approximately 5 ohms (e.g., the low port impedance may be required for a specific application). The receiving antenna 400 is able to achieve the low port impedance of 5 ohms by (i) reducing the number of turns made by the antenna 404 relative to the number of turns made by the antenna 304, and (ii) increasing a width (or widths) of the antenna 404 relative to a width (or widths) of the antenna 300. Also, the receiving antenna 400 is able to achieve the low port impedance by reducing a thickness of the receiving antenna 400, relative to a thickness of the transmitting antenna 300, and offsetting the via 405, at least in some embodiments, from a center of the receiving antenna 400.

Thus, in short, in order to achieve high coupling efficiency and TX-RX port transformation, non-identical antennas (e.g., transmitting antenna 300 and receiving antenna 400) are optimized as a pair. The optimization is achieved through: (i) increasing a thickness of the transmitting antenna 300 relative to a thickness of the receiving antenna 400, as shown in FIGS. 5A and 5B, (ii) increasing a number of turns made by the antenna 304 of the transmitting antenna 300 relative to a number of turns made by the antenna 404 of the receiving antenna 400, as shown in FIGS. 3A and 4A, (iii) varying a spacing and width of antenna segments 306 of the antenna 304 of the transmitting antenna 300 relative to a spacing and width of antenna segments 406 of the antenna 404 of the receiving antenna 400, and (iv) optionally offsetting the vias feeding the antennas 304 and 404 (e.g., in radius and feed clearance), as shown in FIG. 4C. Thus, the asymmetric nature of the coupled antennas provide more degrees of freedom to optimize them for a system with different port impedances.

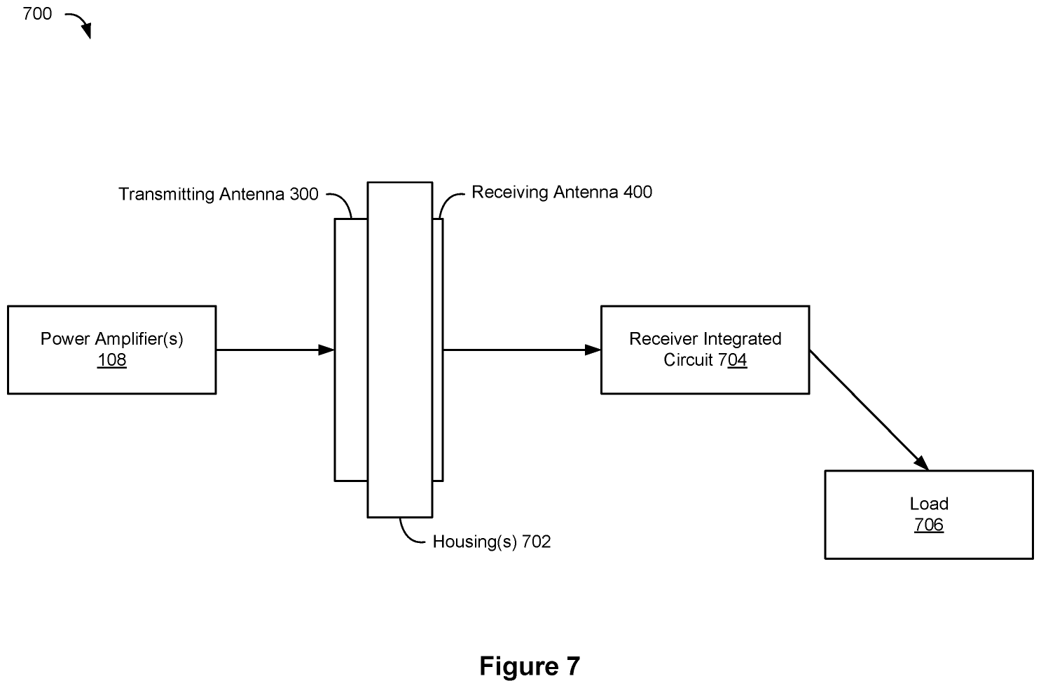

FIG. 7 is a block diagram 700 illustrating an interaction between the transmitting antenna 300 and the receiving antenna 400 (e.g., when the transmitting antenna 300 and the receiving antenna 400 are positioned adjacent to each other and transferring wireless power). As shown, one or more power amplifiers 108 are connected to the transmitting antenna 300 and are configured to provide signals to the transmitting antenna 300. The transmitting antenna 300 uses the signals provided by the one or more power amplifiers 108 to generate electromagnetic waves, which are harvested by the receiving antenna 400. As also shown, the transmitting antenna 300 and the receiving antenna 400 are separated by one or more housings 702. The one or more housings 702, in some embodiments, are distinct antenna covers for the transmitting antenna 300 and the receiving antenna 400. In addition or separately, the one or more housings 702 may be housings of an electronic device (e.g., a mobile phone's housing) and/or a transmitter pad. Power amplifiers 108 are discussed in further detail above with reference to FIG. 1C.

Wireless power harvested by the receiving antenna 400 is provided to a receiver integrated circuit 702. The receiver integrated circuit 702 is configured to convert the harvested wireless power into useable power and provide the useable power to a load 706 (e.g., a battery, power supply, etc.) of an electronic device. Importantly, the receiver integrated circuit 702 is designed to convert high input power to useable power (i.e. over 20 Watt) on the receiver side for a certain output voltage, such as 20 V. To accomplish this, the receiver integrated circuit 702 has low input port impedances (e.g., about 10 times lower than an ideal impedance value of 50 Ohm). In some embodiments, the receiver integrated circuit 702 is an example of the power harvesting circuitry 259 of FIG. 2B.

FIGS. 8A and 8B show energy transfer efficiencies of the receiving antenna 400 and transmitting antenna 300. As shown, the receiving antenna 400 and transmitting antenna 300 are able to achieve an energy transfer efficiency of 90%. Importantly, the receiving antenna 400 and transmitting antenna 300 are able to maintain an energy transfer efficiency even when misaligned (e.g., when the receiving antenna 400 and transmitting antenna 300 are offset by approximately 4 mm, an energy transfer efficiency greater than 80% is achieved). Furthermore, the receiving antenna 400 and transmitting antenna 300 are able to achieve the high energy transfer efficiency while operating at a low frequency. For example, the transmitting antenna 300 may be configured to operate at between 30 and 100 MHz (preferably 40 MHz), meaning that electromagnetic waves radiated by the antenna 304 have wavelengths between approximately 10 meters to 3 meters (preferably 7.5 meters). Nevertheless, even with these low frequencies and large wavelengths, the example near-field power transfer system of FIGS. 3A through 5B remains highly efficient.

In light of these principles, example embodiments are provided below.

In accordance with some embodiments, a near-field charging system for wirelessly charging electronic devices using electromagnetic energy having a low frequency (e.g., below 100 MHz, preferably below 60 MHz) is provided. The near-field charging system includes a transmitting antenna (e.g., transmitting antenna 300, FIG. 3A), including a first substrate (e.g., substrate 302, FIG. 3A) and a first antenna (e.g., antenna 304, FIG. 3A), coupled to the first substrate, that follows a first meandering pattern having a first length. For example, with reference to FIG. 3A, the antenna 304 of the transmitting antenna 300 is a first spiral pattern with a first number of revolutions (e.g., ten complete revolutions).

The near-field charging system also includes a receiving antenna (e.g., receiving antenna 400, FIG. 4A), including a second substrate (e.g., substrate 402, FIG. 4A) and a second antenna (e.g., antenna 404, FIG. 4A), coupled to the second substrate, that follows a second meandering pattern having a second length. For example, with reference to FIG. 4A, the antenna 404 of the receiving antenna 400 is a second spiral pattern with a second number of revolutions, whereby the second number of revolutions is less than the first number of revolutions made by the antenna 304. In addition, the second length is less than the first length.

In some embodiments of the near-field charging system, the transmitting antenna is configured to transmit electromagnetic energy having a frequency at or below 60 MHz (e.g., between 30 MHz and 50 MHz, preferably 40 MHz) to the receiving antenna at an efficiency above 90%, and the receiving antenna is coupled to power-conversion circuitry (e.g., receiver integrated circuit 702, FIG. 7) for converting the electromagnetic energy into usable power for charging or powering an electronic device that is coupled to the receiving antenna and the power-conversion circuitry.

In the near-field charging system, the transmitting antenna has a first port impedance and the receiving antenna has a second port impedance that is less than the first port impedance. For example, the first port impedance may be between 40 and 60 Ohms (preferably 50 Ohms), and the second port impedance may be between 1 and 20 Ohms (preferably 5 Ohms). A difference between the first port impedance and the second port impedance can be attributed to, at least in part, differences between the first meandering pattern and the second meandering pattern. For example, as mentioned above, the first meandering pattern may be longer than the second meandering pattern, and this difference in length can contribute to the port impedance difference. Other factors contributing to the port impedance difference include but are not limited to: number of revolutions made by the first and second antennas, widths of the first and second antennas, thicknesses of the first and second substrates, and locations of feed lines (e.g., via 305 and via 405).

All of these examples are non-limiting and any number of combinations and multi-layered structures are possible using the example structures described above.

Further embodiments also include various subsets of the above embodiments including embodiments in FIGS. 1-8 combined or otherwise re-arranged in various embodiments, as one of skill in the art will readily appreciate while reading this disclosure.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will also be understood that, although the terms “first,” “second,” etc. may be used herein to describe various elements, these elements should not be limited by these terms. These terms are only used to distinguish one element from another. For example, a first region could be termed a second region, and, similarly, a second region could be termed a first region, without changing the meaning of the description, so long as all occurrences of the “first region” are renamed consistently and all occurrences of the “second region” are renamed consistently. The first region and the second region are both regions, but they are not the same region.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A near-field charging system for wirelessly charging electronic devices using electromagnetic energy having a low frequency, the near-field charging system comprising:
a transmitting antenna comprising:
a first substrate; and
a first antenna with a first width, coupled to the first substrate, that follows a first meandering pattern having a first length, wherein the transmitting antenna has a first port impedance; and
a receiving antenna comprising:
a second substrate; and
a second antenna with a second width greater than the first width, coupled to the second substrate, that follows a second meandering pattern having a second length, wherein: (i) the second length is less than the first length, and (ii) the receiving antenna has a second port impedance that is less than the first port impedance,
wherein:
the transmitting antenna is configured to transmit electromagnetic energy having a frequency at or below 60 MHz to the receiving antenna at an efficiency above 90%, and
the receiving antenna is coupled to power-conversion circuitry for converting the electromagnetic energy into usable power for charging or powering an electronic device that is coupled to the receiving antenna and the power-conversion circuitry.
